(19) United States
(12) Patent Application Publication
(10) Pub. No.: US 2026/0346760 A1
(43) Pub. Date: Nov. 5, 2026

(54) GEAR UNIT FOR ADJUSTING A SEAT, IN PARTICULAR LONGITUDINALLY, AS WELL AS ADJUSTABLE SEAT UNIT

(71) Applicant: IMS Gear SE & Co. KGaA, Donaueschingen (DE)

(72) Inventors: Wolfram HOFSCHULTE, Bonndorf (DE); Jens FECHLER, Huefingen (DE); Eric STAEHLE, Bad Duerrheim (DE)

(21) Appl. No.: 19/541,044

(22) Filed: Feb. 16, 2026

(30) Foreign Application Priority Data
Apr. 16, 2025 (EP) 25170953.1

(51) Int. Cl. B60N 2/07; B60N 2/02; B60N 2/06; B60N 2/12; B60N 2/16

(52) U.S. Cl. CPC B60N 2/0705; B60N 2/02246; B60N 2/02253; B60N 2/06; B60N 2/0722; B60N 2/12; B60N 2/1615

(57) ABSTRACT

Gear unit (10) for adjusting a seat, in particular a vehicle seat, in particular longitudinally, with a housing (20) comprising a first housing part (22), a gear stage (26) arranged in the housing (20) and a retaining element (18) for establishing a mechanical operative connection between the gear unit (10) and the seat, wherein at least one part (42, 50) of the retaining element (18) is integrally molded onto the first housing part (22), as well as an adjustable seat unit, in particular for a vehicle, comprising a seat and a gear unit (10).

Seat longitudinal adjustment devices are frequently used for the electrically motorized adjustment of seats in the longitudinal direction of a motor vehicle. Seat longitudinal adjustment devices usually have a spindle gear unit, by means of which speed and torque are transmitted between a gear worm and a gear spindle. To this end, a spindle nut is arranged on the gear spindle and in turn has a toothed ring with external teeth in engagement with the gear worm. Such spindle gear units are known, for example, from EP 1 992 842B1, DE 103 62 040B4 , DE 10 2004 046 048 B3 or KR 10 1 920 222B1 .

As can be seen, in particular, from the two documents EP 1 992 842 B1 and DE 103 62 040B4 , the spindle gear units for use in a seat longitudinal adjustment device can be arranged in a U-shaped gear mechanism retainer. The gear mechanism housing of the spindle gear unit is often held in the gear mechanism retainer by means of resilient bearing shells. The gear mechanism retainer may in turn be coupled to the seat that is to be adjusted.

The known solutions therefore have a relatively high number of parts. Since seat longitudinal adjustment devices are usually manufactured in very large quantities, such systems involve correspondingly high costs, especially in assembly, but also in handling and the associated logistics.

It is the object of the invention to provide an arrangement for adjusting a seat that has low manufacturing costs and high assembly reliability.

The object is achieved according to the invention by a gear unit having the features of claim 1 and by an adjustable seat unit having the features of claim 15.

Advantageous embodiments and developments of the invention are specified in the dependent claims.

An inventive gear unit for adjusting a seat, in particular a vehicle seat, in particular longitudinally, comprises a housing having a first housing part, a gear stage arranged in the housing and a retaining element for establishing a mechanical operative connection between the gear unit and the seat, wherein at least one part of the retaining element is integrally molded onto the first housing part. This allows the gear unit to have a comparatively small number of parts. The gear stage is preferably designed as a worm gear having a worm and a worm wheel. The worm wheel and/or the worm may be mounted in the housing. The worm wheel is preferably designed as a spindle nut having a spindle axis. The worm is preferably mounted rotatable about a worm axis which is particularly preferably arranged perpendicular to the spindle axis. The gear stage can thus be driven by means of a threaded spindle preferably arranged on the spindle axis and in engagement with the worm wheel. The gear unit may substantially be T-shaped with a horizontal portion and a vertical portion opening into the horizontal portion. The vertical portion may substantially be formed by the housing and the horizontal portion substantially by the retaining element. The retaining element is therefore preferably arranged parallel to the spindle axis.

The housing may have a second housing part, wherein at least part of the retaining element is integrally molded onto the second housing part. The housing and the retaining element may therefore be designed separately. The housing preferably consists of the first housing part and the second housing part. The worm wheel and/or the worm may each be mounted in the first housing part and the second housing part. Bearing seats that may be designed as worm wheel bearing seats intended for the worm wheel on the one hand or as worm bearing seats intended for the worm on the other hand may be arranged in the housing. In particular, the worm wheel bearing seats may be designed as split bearing seats.

In one preferred embodiment of the invention, the retaining element has a first retaining portion, wherein a first part of the first retaining portion is integrally molded onto the first housing part.

A second part of the first retaining portion may be integrally molded onto the second housing part. The first retaining portion is preferably formed by the first part and the second part of the first retaining portion. The complete first retaining portion is preferably formed during the assembly of the gear unit by joining the first housing part and the second housing part to form the housing.

Preferably, a first first fastening hole is arranged in the first part of the first retaining portion and a first second fastening hole is arranged in the second part of the first retaining portion, wherein the first first fastening hole and the first second fastening hole are arranged coaxially to each other. The mechanical operative connection between the gear unit and the seat can be established by means of the first fastening holes. Even before this mechanical connection is made, assembly or transport safety can be established during the assembly of the gear unit by placing a screw or bolt in both first fastening holes. The first first fastening hole is preferably designed as a threaded hole having a first thread, wherein the first thread may be arranged in a first collar of the second retaining portion, which first collar is arranged as a projection or recess. The first second fastening hole is preferably designed without threads. The first first fastening hole and/or the first second fastening hole are preferably designed as a through-holes. For securing the gear unit during assembly or transport, a screw, in particular, can be arranged in the first second fastening hole and screwed into the thread of the first first fastening hole. The first fastening holes are preferably arranged perpendicular to the spindle axis.

In one preferred embodiment of the invention, the retaining element has a second retaining portion, wherein a second part of the second retaining portion is integrally molded onto the first housing part. The retaining element is preferably aligned along the spindle axis. The first retaining portion and/or the second retaining portion are preferably arranged one behind the other in the direction of the spindle axis. The first part of the first retaining portion may be arranged closer to the spindle axis than the second part of the second retaining portion. The first part of the first retaining portion and the second part of the second retaining portion are preferably designed as a flat surface and are particularly preferably arranged parallel to a plane arranged parallel to the spindle axis and parallel to the screw axis.

A first part of the second retaining portion may be integrally molded onto the second housing part. The first part of the second retaining portion may be arranged closer to the spindle axis than the second part of the first retaining portion. The first part of the second retaining portion and the second part of the first retaining portion are preferably designed as a flat surface and are particularly preferably arranged parallel to a plane arranged parallel to the spindle axis and parallel to the screw axis.

A second first fastening hole is arranged in the first part of the second retaining portion, and a second second fastening hole is arranged in the second part of the second retaining portion, wherein the second first fastening hole and the second second fastening hole are arranged coaxially to each other. Corresponding to the first fastening holes, the mechanical operative connection between the gear unit and the seat can be established by means of the second fastening holes. Even before this mechanical operative connection is made, assembly or transport safety can be established during the assembly of the gear unit in that a screw or bolt is arranged in both second fastening holes. The second first fastening hole is preferably designed as a threaded hole having a second thread, wherein the second thread may be arranged in a second collar of the second retaining portion, which collar is arranged as a projection or recess. The second second fastening hole is preferably designed without threads. The second first fastening hole and/or the second second fastening hole are preferably designed as through-holes. For securing the gear unit during assembly or transport, a screw, in particular, can be placed in the second second fastening hole and screwed into the thread of the second fastening hole. The second fastening holes are preferably arranged perpendicular to the spindle axis.

In a further development of the invention, the first part of the first retaining portion and the first part of the second retaining portion on the one hand and/or the second part of the first retaining portion and the second part of the second retaining portion on the other hand may each have an engagement element for producing a form-fit engagement with the seat. This allows the arrangement of the first housing part and the second housing part to be defined relative to each other before the housing is actually attached to the seat. The engagement element can thus serve as an assembly safety feature and simplify the mounting of the gear unit to the seat. The seat may have a counterpart which can preferably be arranged in a form fit with the engagement element. The engagement element is preferably designed as a projection or recess and may be arranged in an annular shape around one of the first fastening holes or one of the second fastening holes.

In one preferred embodiment of the invention, the first housing part and the at least one part of the retaining element molded thereon are identical to the second housing part and the at least one part of the retaining element molded thereon. This reduces the effort required to manufacture the gear mechanism, especially with regard to the necessary logistics, and simplifies assembly.

The retaining element is preferably arranged at a first end of the housing, and the first housing part and the second housing part are connected, in a form fit and/or in a material fit, to each other at a second end of the housing opposite the first end. For this purpose, in particular riveting, crimping, pressing, or welding of the two housing parts may be considered. This allows the gear unit to be secured for transport and assembly. In addition, this can prevent the housing from bending under load during operation of the gear mechanism housing.

The first housing part and the second housing part may each have an interface contour against which the other housing part rests, wherein the interface contour is designed such that there is exactly one possibility for the form-fit assembly of the first housing part and the second housing part. The first housing part and the second housing part may therefore be designed according to the Poka-Yoke principle. The same applies preferably to the parts of the retaining elements that are molded thereon. This simplifies the assembly of the gear unit.

A gear wheel of the gear stage may be mounted in the housing such that a bearing bushing is arranged on one side between the gear wheel and the housing. This allows the position of the gear wheel to be adjusted relative to the first housing part and/or the second housing part. If the gear wheel has two differently designed bearing points, these differences can be compensated for by means of the bearing bushing in order to be able to mount the gear in identically designed housing parts. The bearing bushing is preferably arranged on one side between the worm and the first housing part.

The first housing part and the at least one part of the retaining element molded thereon may be designed as stamped-bent parts and/or a metal die-cast part, in particular a zinc die-cast part or an aluminum die-cast part. The same preferably applies to the second housing part and at least part of the retaining element molded thereon. The first housing part and the second housing part are preferably made of the same material and/or using the same manufacturing process.

An inventive adjustable seat unit, in particular for a vehicle, comprises a seat and a gear unit as described above, wherein the retaining element of the gear unit is attached to a seat rail of the seat. The seat unit may also include a threaded spindle in engagement with the spindle nut. The seat unit preferably has two gear units, two seat rails and two threaded spindles, each designed or arranged correspondingly. The seat unit is preferably designed for longitudinal adjustment of the seat.

An exemplary embodiment of the invention is explained using the following figures. In the drawings:

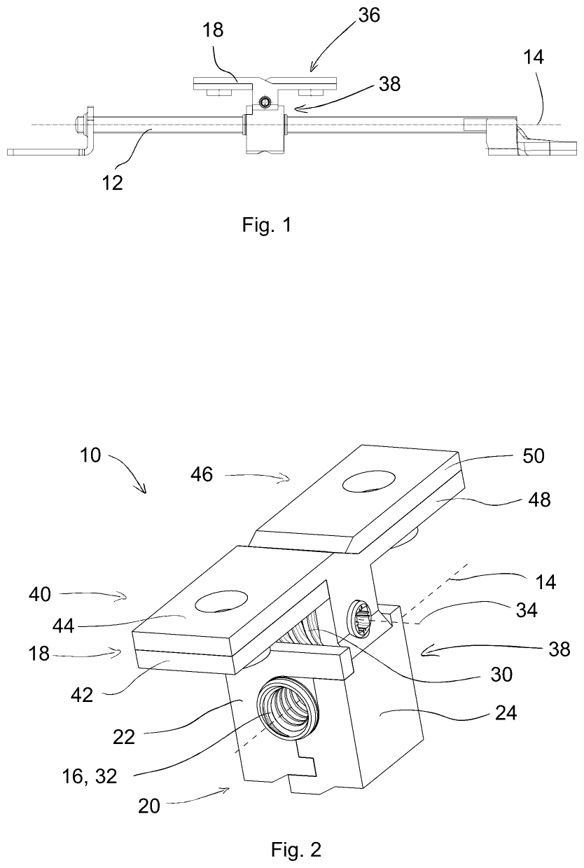

FIG. 1 is a schematic representation of an exemplary embodiment of a gear unit on a threaded spindle;

FIG. 2 is a schematic perspective view of the exemplary embodiment shown in FIG. 1;

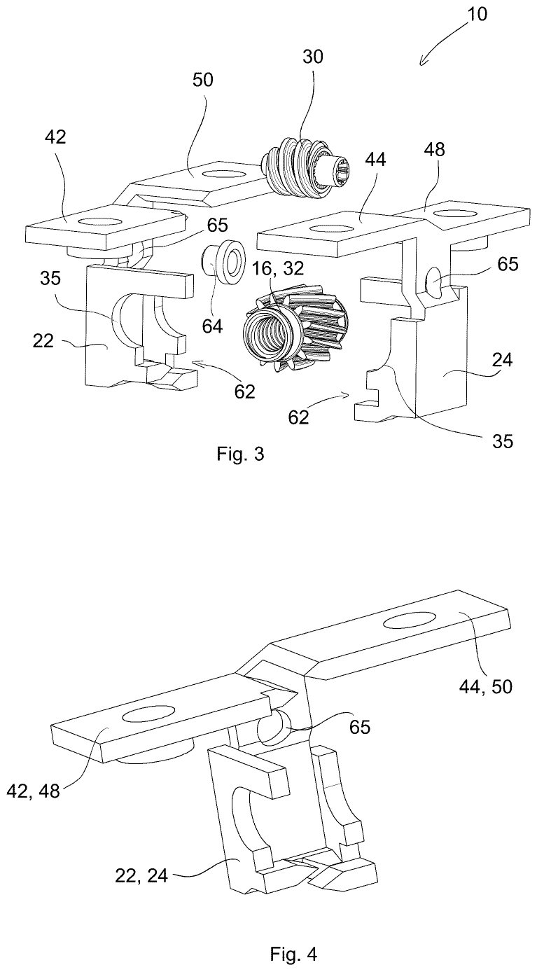

FIG. 3 is a schematic exploded view of the exemplary embodiment shown in FIG. 1;

FIG. 4 is a schematic perspective view of a housing part with retaining portions molded thereon, of the exemplary embodiment shown in FIG. 1;

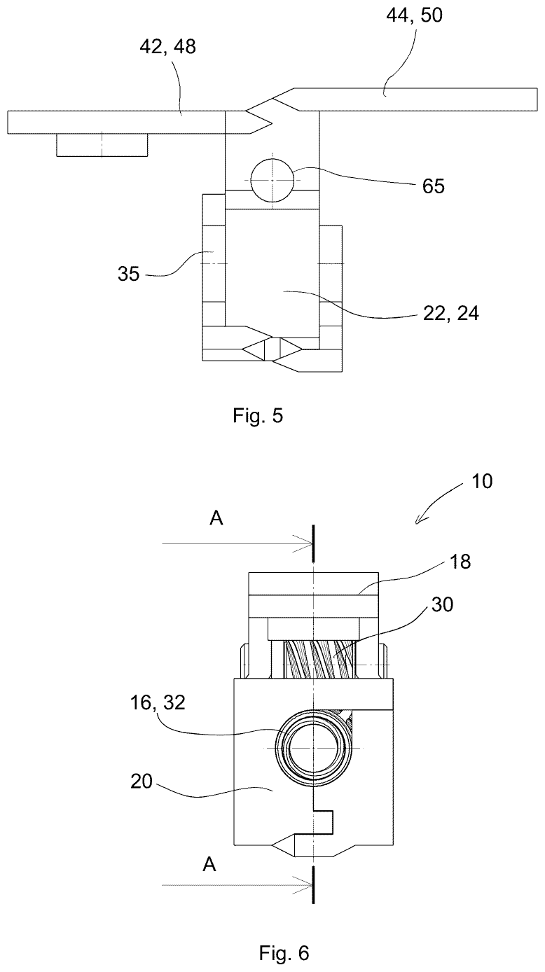

FIG. 5 is a schematic top view of the housing part shown in FIG. 4 with retaining portions molded thereon;

FIG. 6 is a schematic first side view of the exemplary embodiment shown in FIG. 1 with the sectional plane AA indicated;

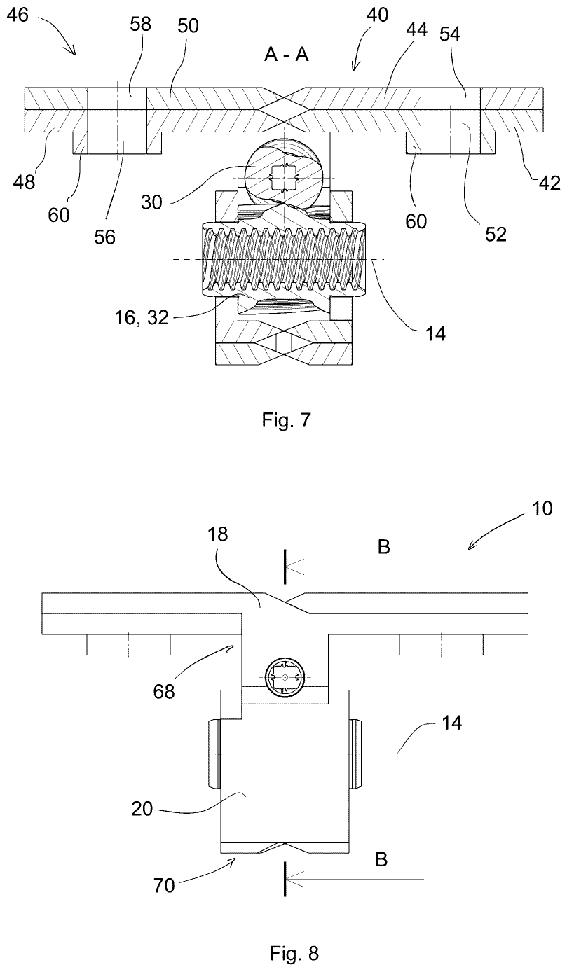

FIG. 7 is a schematic longitudinal sectional view of the exemplary embodiment shown in FIG. 1 along the sectional plane AA indicated in FIG. 6;

FIG. 8 is a schematic second side view of the exemplary embodiment shown in FIG. 1 with the sectional plane BB indicated; and

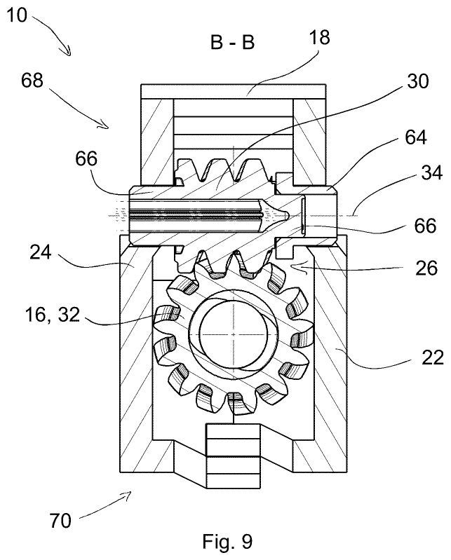

FIG. 9 is a schematic cross-sectional view of the exemplary embodiment shown in FIG. 1 along the sectional plane BB indicated in FIG. 8.

FIGS. 1 to 9 show different views of an exemplary embodiment. For the sake of clarity, not all reference numbers are used in every figure. The same reference numbers are used for identical and functionally identical parts.

FIG. 1 shows part of an adjustable seat unit, comprising an exemplary embodiment of a gear unit 10 for adjusting a seat, in particular a vehicle seat, in particular longitudinally, and a threaded spindle 12 on which the gear unit 10 is arranged. The threaded spindle 12 is arranged on a spindle axis 14 of a spindle nut 16 of the gear unit 10. A retaining element 18 of the gear unit 10 can preferably be attached to a seat rail (not shown) of a seat (also not shown) of the seat unit. The seat unit comprises the gear unit 10 and the threaded spindle 12, preferably two of each. The seat unit is preferably designed for longitudinal adjustment of the seat along the spindle axis 14.

The gear unit 10 is shown in a perspective view in FIG. 2. The exploded view in FIG. 3 illustrates the individual components of the gear unit 10. The gear unit 10 comprises a housing 20 having a first housing part 22, a second housing part 24, a gear stage 26 arranged in the housing and the retaining element 18 for establishing a mechanical operative connection between the gear unit 10 and the seat.

The gear stage 26 is designed as a worm gear having a worm 30 and a worm wheel 32. The worm wheel 32 and the worm 30 are mounted in the housing 20. The worm wheel 32 forms the spindle nut 16 having the spindle axis 14. The worm 30 is rotatably mounted about a worm axis 34 arranged perpendicular to the spindle axis 14. The worm wheel 32 and the worm 30 are each mounted in the first housing part 22 and second housing part 24. The housing 20 has worm wheel bearing seats 35 provided for mounting the worm wheel 32 and designed as split bearing seats. As illustrated in FIG. 3, the gear unit 10 has a comparatively small number of parts. After assembly in the seat unit, the gear stage 26 can be driven by means of the threaded spindle 12, which is in engagement with the worm wheel 32 and is arranged on the spindle axis 14 (see FIG. 1).

As shown, in particular, in FIGS. 1 and 2, the gear unit 10 is substantially T-shaped having a horizontal portion 36 and a vertical portion 38 opening into the horizontal portion 36. The vertical portion 38 is substantially formed by the housing 20 and the horizontal portion 36 is substantially formed by the retaining element 18. The retaining element 18 is thus arranged parallel to the spindle axis 14.

FIGS. 2 and 3, in particular, show that the retaining element 18 has a first retaining portion 40, wherein a first part 42 of the first retaining portion 40 is integrally molded onto the first housing part 22 and a second part 44 of the first retaining portion 40 is integrally molded onto the second housing part 24. The complete first retaining portion 40 is thus formed during the assembly of the gear unit 10 by joining the first housing part 22 and the second housing part 24 to form the housing 20.

The retaining element 18 has a second retaining portion 46 in addition to the first retaining portion 40. A first part 48 of the second retaining portion 46 is integrally molded onto the second housing part 24. A second part 50 of the second retaining portion 46 is integrally molded onto the first housing part 22. The complete second retaining portion 46 is thus formed during the assembly of the gear unit 10 by joining the first housing part 22 and the second housing part 24 to form the housing 20.

As shown in FIGS. 2 and 3, the first parts 42, 48 and the second parts 44, 50 of the retaining portions 40, 46 are each formed as flat surfaces and arranged parallel to a plane (not shown) that is parallel to the spindle axis 14 and parallel to the worm axis 34. The first parts 42, 48 of the retaining portions 40, 46 are each arranged closer to the spindle axis 14 than the second parts 44, 50 of the retaining portions 40, 46. The retaining element 18 is aligned along the spindle axis 14. The first retaining portion 40 and the second retaining portion 46 are arranged one behind the other in the direction of the spindle axis 14.

As shown, in particular, by the sectional view of FIG. 7, a first first fastening hole 52 is arranged in the first part 42 of the first retaining portion 40 and a first second fastening hole 54 is arranged in the second part 44 of the first retaining portion 40, wherein the first first fastening hole 52 and the first second fastening hole 54 are arranged coaxially to each other.

A second first fastening hole 56 is arranged in the first part 48 of the second retaining portion 46 and a second second fastening hole 58 is arranged in the second part 50 of the second retaining portion 46, wherein the second first fastening hole 56 and the second second fastening hole 58 are arranged coaxially to each other. The fastening holes 52, 54, 56, 58 are arranged perpendicular to the spindle axis 14.

The mechanical operative connection between the gear unit 10 and the seat can be established by means of the first fastening holes 52, 54 and by means of the second fastening holes 56, 58. Even before this mechanical operative connection is made, assembly or transport safety can be established during the assembly of the gear unit 10 in that a screw or bolt is placed into each in each of the two first fastening holes 52, 54 and the two second fastening holes 56, 58.

The first first fastening hole 52 and the second first fastening hole 56 may each be designed as a threaded hole (not shown). The first second fastening hole 54 and the second second fastening hole 58 are preferably each designed without threads. All fastening holes 52, 54, 56, 58 are preferably designed as through-holes. For securing the gear unit 10 during assembly or transport, such a screw can be screwed into the first second fastening hole 54 and into the thread of the first first fastening hole 52. Similarly, a screw can be arranged in the second second fastening hole 58 and screwed into the thread of the second first fastening hole 56.

As further shown in the sectional view in FIG. 7, the first part 42 of the first retaining portion 40 and the first part 48 of the second retaining portion 46 each have a collar 60 formed as a projection. At least a portion of the threads (not shown) of the first first fastening hole 52 and the second first fastening hole 56 is arranged in each of the collars 60. As shown especially in FIG. 3, the first housing part 22, the first part 42 of the first retaining portion 40 molded thereon and the second part 50 of the second retaining portion 46 molded thereon are identical to the second housing part 24, the second part 44 of the first retaining portion 40 molded thereon and the first part 48 of the second retaining portion 46 molded thereon. The component shown in FIGS. 4 and 5 thus represents both the first housing part 22 having the molded-on parts 42, 50 and the second housing part 24 having the parts 44, 48 molded thereon.

As shown in FIGS. 2 and 3, the first housing part 22 and the second housing part 24 each have an interface contour 62 against which the other of the housing parts 22, 24 rests, wherein the interface contour 62 is designed such that there is exactly one possibility for the form-fit assembly of the first housing part 22 and the second housing part 24. The first housing part and the second housing part may therefore be designed according to the Poka-Yoke principle. The same applies to the parts 42, 44, 48, 50 of the retaining element 18 which are molded thereon.

As shown, in particular by the sectional view in FIG. 9, the worm 30 of the gear stage 26 is mounted in the housing 20 such that a bearing bushing 64 is arranged on one side between the worm 30 and the housing 20, specifically between the worm 30 and the first housing part 22. This allows the screw 30 to be positioned asymmetrically relative to the housing 20. Furthermore, the screw 30 can thus be mounted in the identically designed housing parts 22, 24, which therefore also have identically designed screw bearing seats 65, although the screw 30 has two differently designed bearing points 66.

As also shown in FIGS. 8 and 9, the retaining element 18 is arranged at a first end 68 of the housing 20. The first housing part 22 and the second housing part 24 are connected to each other in a form fit and/or material fit at a second end 70 of the housing 20 opposite the first end 68. For this purpose, in particular riveting, crimping, pressing, or welding of the two housing parts 22, 24 may be considered.

### LIST OF REFERENCE SYMBOLS

10 Gear unit
12 Threaded spindle
14 Spindle axis
16 Spindle nut
18 Retaining element
20 Housing
22 First housing part
24 Second housing part
26 Gear stage
30 Worm
32 Worm wheel
34 Worm axis
35 Worm wheel bearing seat
36 Horizontal portion
38 Vertical portion
40 First retaining portion
42 First part
44 Second part
46 Second retaining portion
48 First part
50 Second part
52 First first fastening hole
54 First second fastening hole
56 Second first fastening hole
58 Second second fastening hole
60 Collar
62 Interface contour
64 Bearing bushing
65 Worm bearing seat
66 Bearing point
68 First end
70 Second end

1. A gear unit (10) for adjusting a seat, in particular a vehicle seat, in particular longitudinally, with a housing (20) comprising a first housing part (22), a gear stage (26) arranged in the housing (20) and a retaining element (18) for establishing a mechanical operative connection between the gear unit (10) and the seat, characterized in that at least one part (42, 50) of the retaining element (18) is integrally molded onto the first housing part (22).

2. The gear unit (10) according to claim 1, characterized in that the housing (20) has a second housing part (24), wherein at least one part (44, 48) of the retaining element (18) is integrally molded onto the second housing part (24).

3. The gear unit (10) according to any of the preceding claims, characterized in that the retaining element (18) has a first retaining portion (40), wherein a first part (42) of the first retaining portion (40) is integrally molded onto the first housing part (22).

4. The gear unit (10) according to claims 2 and 3, characterized in that a second part (44) of the first retaining portion (40) is integrally molded onto the second housing part (24).

5. The gear unit (10) according to claim 4, characterized in that a first first fastening hole (52) is arranged in the first part of the first retaining portion (40) and a first second fastening hole (54) is arranged in the second part of the first retaining portion (40), wherein the first first fastening hole (52) and the first second fastening hole (54) are arranged coaxially to each other.

6. The gear unit (10) according to any of the preceding claims, characterized in that the retaining element (18) has a second retaining portion (46), wherein a second part (50) of the second retaining portion is integrally molded onto the first housing part (22).

7. The gear unit (10) according to claims 2 and 6 or according to claims 2 and 6 and any of the preceding claims, characterized in that a first part (48) of the second retaining portion (46) is integrally molded onto the second housing part (24).

8. The gear unit (10) according to claim 7, characterized in that a second first fastening hole (56) is arranged in the first part (48) of the second retaining portion (46), and a second second fastening hole (58) is arranged in the second part (50) of the second retaining portion (46), wherein the second first fastening hole (56) and the second second fastening hole (58) are arranged coaxially to each other.

9. The gear unit (10) according to any of claims 7 to 8, characterized in that the first part (42) of the first retaining portion (40) and the first part (48) of the second retaining portion (46) on the one hand and/or the second part (44) of the first retaining portion (40) and the second part (50) of the second retaining portion (46) on the other hand each have an engagement element for producing a form-fit with the seat.

10. The gear unit (10) according to claim 2 or according to claim 2 and any of the preceding claims, characterized in that the first housing part (22) and the at least one part (42, 50) of the retaining element (18) molded thereon are identical to the second housing part (24) and the at least one part (44, 48) of the retaining element (18) molded thereon.

11. The gear unit (10) according to claim 2 or according to claim 2 and any of the preceding claims, characterized in that the retaining element (18) is arranged at a first end (68) of the housing (20) and the first housing part (22) and the second housing part (24) are connected, in a form fit and/or in a material fit, to each other at a second end (70) of the housing (20) opposite the first end (68).

12. The gear unit (10) according to claim 2 or according to claim 2 and any of the preceding claims, characterized in that the first housing part (22) and the second housing part (24) each have an interface contour (62) against which the respective other housing part rests, wherein the interface contour (62) is designed such that there is exactly one possibility for the form-fit assembly of the first housing part (22) and the second housing part (24).

13. The gear unit (10) according to any of the preceding claims, characterized in that a gear of the gear stage (26) is mounted in the housing (20) such that a bearing bushing (64) is arranged on one side between the gear wheel and the housing (20).

14. The gear unit (10) according to any of the preceding claims, characterized in that the first housing part (22) and the at least one part (42, 50) of the retaining element (18) molded thereon are designed as stamped-bent parts and/or a metal die-cast part, in particular a zinc die-cast part or aluminum die-cast part.

15. An adjustable seat unit, in particular for a vehicle, comprising a seat and a gear unit (10) according to any of the preceding claims, wherein the retaining element (18) of the gear unit (10) is attached to a seat rail of the seat.
